(19) United States
(12) Patent Application Publication
(10) Pub. No.: US 2011/0291902 A1
(43) Pub. Date: Dec. 1, 2011

(54) WIDEBAND L-SHAPED CIRCULAR POLARIZED MONOPOLE SLOT ANTENNA

(76) Inventors: Seyed Pedram Mousavi Bafrooei, Edmonton (CA); William Ben Miners, Guelph (CA); Otman A. Basir, Waterloo (CA)

(21) Appl. No.: 13/115,169

(22) Filed: May 25, 2011

Related U.S. Application Data
(60) Provisional application No. 61/347,936, filed on May 25, 2010.

(51) Int. Cl. H01Q 13/10

(52) U.S. Cl. 343/770

(57) ABSTRACT

A wideband circularly polarized L-shaped monopole slot antenna has a single C-shaped feed. The measured results demonstrate that the antenna has 23% of circular polarization bandwidth (Axial Ratio<3 dB and Return Loss<−10 dB). The monopole slot antenna occupies a half area on the corner of circuit board compared to half-wavelength slot antenna that requires the area at the center of the board. This feature is attractive for compact wireless devices operate at low frequencies in which circuit board floor planning and signal routing are major concerns. The antenna is extremely low cost and does not require any truncation corner, reflector surface and via connection which increase the fabrication cost.

This application claims priority to U.S. Provisional Application Ser. No. 61/347,936, filed May 25, 2010.

### BACKGROUND

Circular polarization is getting more attention in modern mobile wireless communication. The advantage of circular polarization scheme is more pronounced in direct satellite to land communication as circular polarization is more resistant to the bad weather conditions and less sensitive to the orientation of the corresponding mobile device. In many applications wideband circular polarization is desirable. There are several design techniques proposed in the literature to achieve wideband circular polarization.

One of the methods is sequential rotation. This method can potentially increase the axial ratio bandwidth considerably (about 20%). However, it requires a wideband power combiner and a quadrature phase shifter and it occupies large area. The other method is using a printed slot antenna. The printed slot antennas usually have wider impedance bandwidth compared to microstrip antennas. Several designs of circular polarization antenna using printed slot antenna have been proposed recently. The common problem among them is the antenna occupies a large board space in the middle of system circuit board of the mobile device and makes the circuit floor planning and signal line routing difficult. In addition, the axial ratio bandwidth is less than 5% which is not suitable for many applications. In one example, 18% circular polarization bandwidth was obtained at the expense of removing a significant portion of circuit board. Also the effect of the ground plane is not clear. The circular polarization bandwidth in another example is only 6%. The design is sensitive to the ground plane size and many design parameters need to be optimized, which impose unnecessary challenges for designers and manufacturers. Another example reports 47% circular polarization bandwidth. However, this bandwidth is achieved by truncating the corner of circuit board and using the reflector metallic surface. The truncated corner increase the manufacturing cost and reducing the valuable circuit board real-estate. Using the reflector surface significantly increases the profile of mobile devices particularly for applications at lower frequencies such as GPS and low data rate Iridium Satellite access. Also the design is sensitive to the precise distance between the antenna and the reflector.

Recently several designs of monopole slot antennas for linear (vertical) polarization have been demonstrated. The monopole slot antennas operate at their 0.25λ resonant mode compared to half-wavelength slot antennas. In addition, the monopole slot antennas can be implemented at the corner of system circuit board, which make the floor planning and signal routing more comfortable. Those features make them attractive for mobile applications that require compact size antennas.

### SUMMARY

An antenna according to one example of the present invention provides a wideband circular polarization L-shaped monopole slot antenna with C-shaped feed. The proposed antenna can be placed at the top portion of system ground plane, rather than the designs with the slot at the center of the ground plane. A circular polarization bandwidth (Axial Ratio<3 dB and Return Loss<−10 dB) of more than 23% can be achieved without using a truncated corner, a reflector surface or connecting vias for feed line which make it easy to fabricate at low cost for practical applications.

### BRIEF DESCRIPTION OF THE DRAWINGS

FIG. 1 is a schematic of one antenna according to the present invention.

FIG. 2a is a graph of the simulated and measured return loss.

FIG. 2b is a graph of the simulated and measured gain and axial ratio.

FIG. 3a is a graph of the simulated and measured radiation patterns at 1.6 GHz.

FIG. 3b is a graph of the simulated and measured radiation patterns at 1.7 GHz.

FIG. 4a is a graph of the effect of the ground plane size on axial ratio.

FIG. 4b is a graph of the effect of the ground plane size on return loss.

FIG. 5a is a graph of the effect of the slot size on axial ratio.

FIG. 5b is a graph of the effect of the slot size on return loss.

FIG. 6a is a graph of the effect of the horizontal feed length size on axial ratio.

FIG. 6b is a graph of the effect of the horizontal feed length on return loss.

### DETAILED DESCRIPTION OF A PREFERRED EMBODIMENT

Antenna Structure

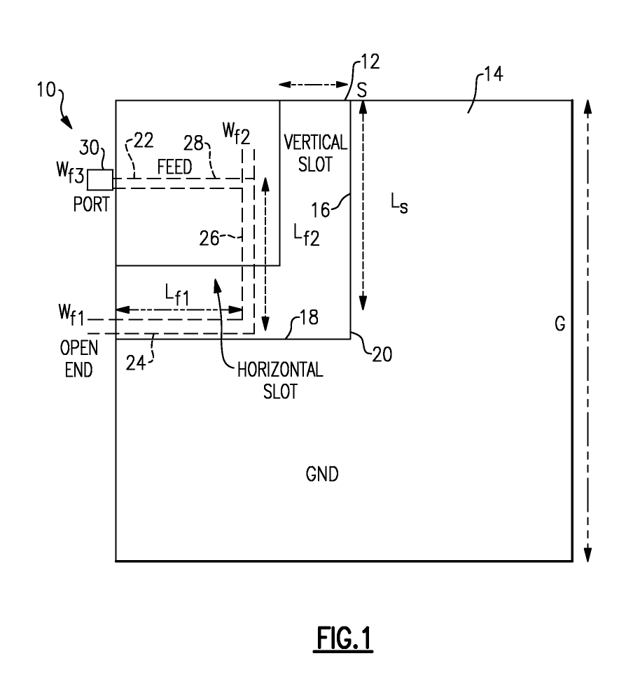

One proposed structure of the antenna 10 is shown in FIG. 1. The antenna 10 is fabricated on the FR4 substrate 12 with dielectric constant of 4.2 and the loss tangent of 0.02. The thickness of the substrate 12 is 0.8 mm. The size of the antenna 10 is (G×G) 70×70 mm2 which is suitable for most mobile devices. A ground plane 14 (e.g. copper or other metal) is formed on the substrate 12.

An L-shaped monopole slot 20 is cut from the ground plane 14 at left corner of the board 12. The L-shaped monopole slot 20 includes a horizontal slot (arm) 18 and a vertical slot (arm) 16. The width of each arm 16, 18 is S=11 mm and the length is Lₛ=30.5 mm.

A C-shaped feed line 22 is etched (e.g. copper or other metal) on the other side of the substrate 12. The lower arm 24 of the feed which is parallel to horizontal slot 18 has the width of W_{f1}=2 mm and the length of Lₙ=21 mm. The distance between the lower edge of the lower arm 24 and upper edge of slot 18 is 0.5 mm and the line is terminated to the edge of the board 12 (open) as opposed to the line in a proposed design which required terminated via to the ground on the other side of the substrate. The vertical portion 26 of C section feed line 22 has the width of (W_{f2}) 1.5 mm and the length of (L_{f2}) 23.75 mm. The upper arm 28 of C section feed line 22 is terminated to a connector 30 at the edge of the board 12 (W_{f3}=1.5). The feed line 22 is designed in order to get the wide overlapped bandwidth in terms of axial ratio and return loss.

Simulations and Measurements Results

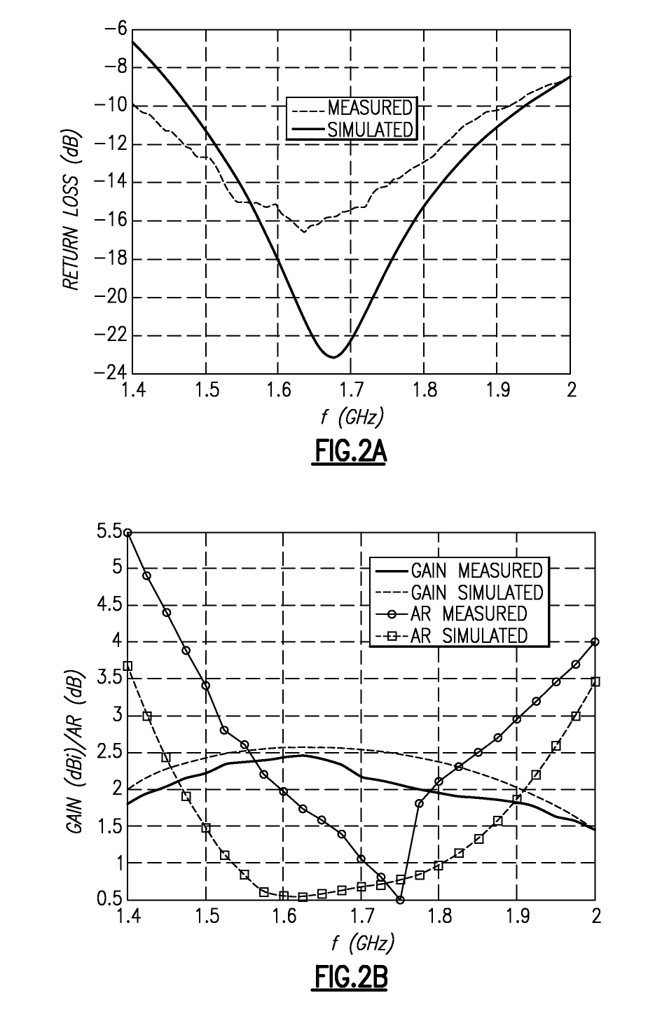

The simulations were performed by Ansoft HFSS. The simulated and measured return loss, axial ratio, and gain are shown in FIG. 2 (a & b). The measured and simulated return losses are in good agreement and demonstrate a bandwidth (return loss <−10 dB) of 30% (1410-1910 MHz) and 26% (1480-1930 MHz) respectively. The simulated axial ratio shows 32% (1425-1975 MHz) bandwidth (AR<3 dB). The measurements, however, indicate a 23% (1500-1900 MHz) bandwidth. This can be attributed to edge connector which creates asymmetric in antenna configuration and the measurements setups. Unlike some previous designs, the AR and return loss bandwidth are overlapped with each other perfectly and therefore the total measured circular polarization bandwidth of the antenna is 23%. This bandwidth is obtained without using a reflector surface that significantly increases the height of the antenna (λ4=5 cm) and causes the fabrication errors and makes the antenna unsuitable for low profile mobile applications. Compared to the previous design, no corner truncation technique is used in the design which saves valuable space to implement other system components and reduce the sensitivity to this parameter.

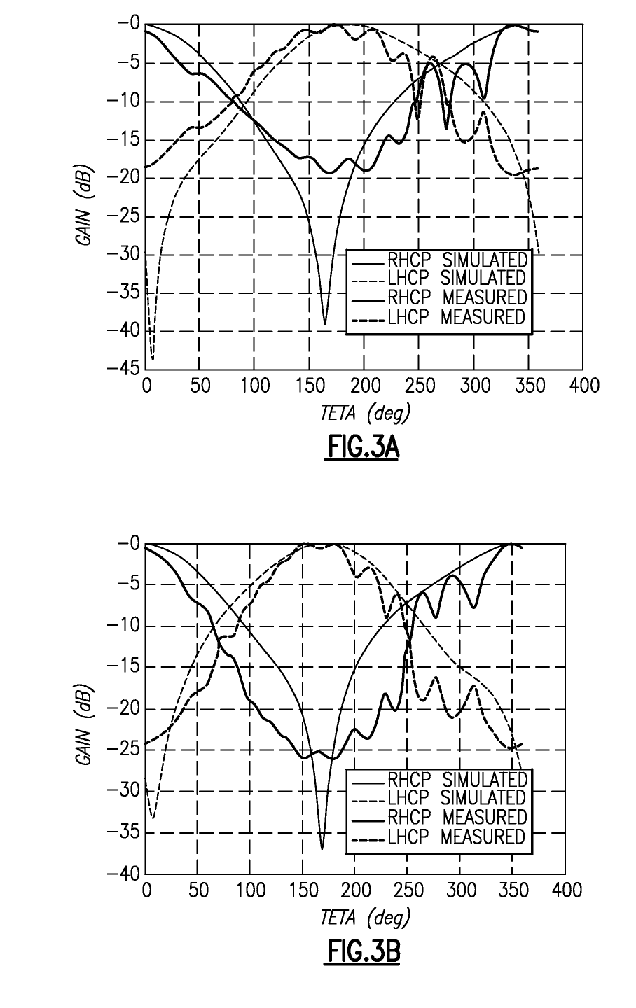

The simulated and measured radiation patterns at 1600 and 1700 MHz are shown in FIG. 3. The antenna is designed to produce the right-hand circular polarization at broadside (Θ =0° with left-hand circular polarization is considered to be cross-polarization. The measured cross-polarization for 1600 and 1700 MHz are −19 and −24.7 dB respectively. The oscillatory measured pattern around 0=270° is due to the effect of connector, antenna measurement mounting and cables. FIG. 2b also demonstrates the simulated and measured gain of the antenna vs. frequency. The overall measured gain varies between 1.8 and 2.45 dBi with efficiency of better than 90% for the axial ratio of better than 3.

Parametric Analysis

In this section is a summary of the results of an extensive parametric study and description of the effect of the most important parameters on the axial ratio and return loss. The parameters considered are the size of ground plane (G), slot width (S), and length of the lower arm of the feed which is parallel to horizontal slot (L_{f1}). For each varying parameter the other dimensions are fixed to the values indicated in FIG. 1. The simulation analyses are performed using Ansoft HFSS.

Varying Ground Plane Size

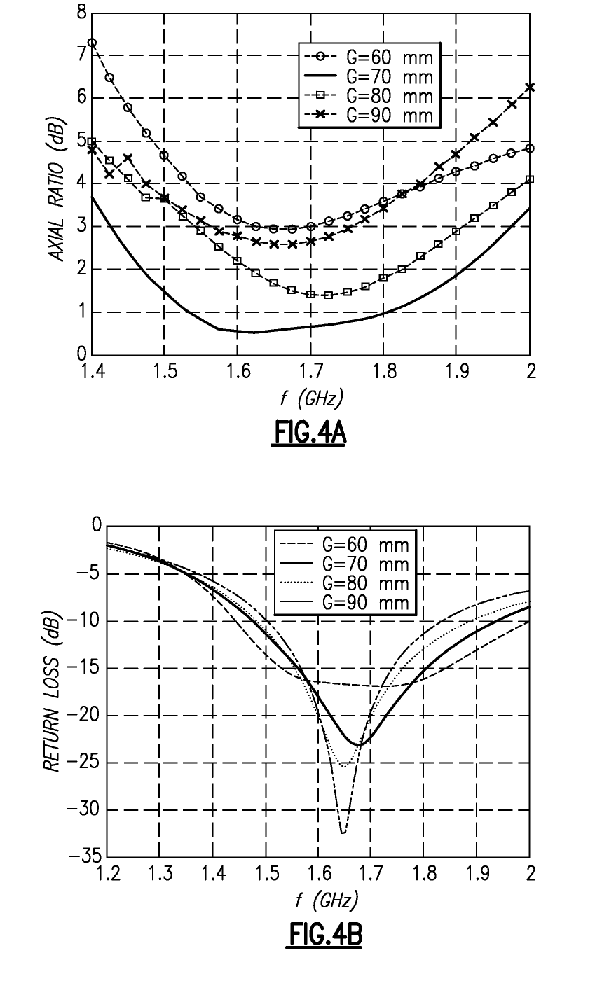

The effect of the different ground plane sizes on axial ratio and return loss are shown in FIG. 4 a&b. For small ground plane size (G=60 mm) the return loss bandwidth is about 32%, however, the axial ratio bandwidth is less than 5%. By increasing the ground plane sizes the return loss bandwidth decreases and the axial ratio bandwidth increases up to G=70 mm. For G>80 mm both return loss and axial ratio bandwidth are reduced considerably.

Varying Slot Width

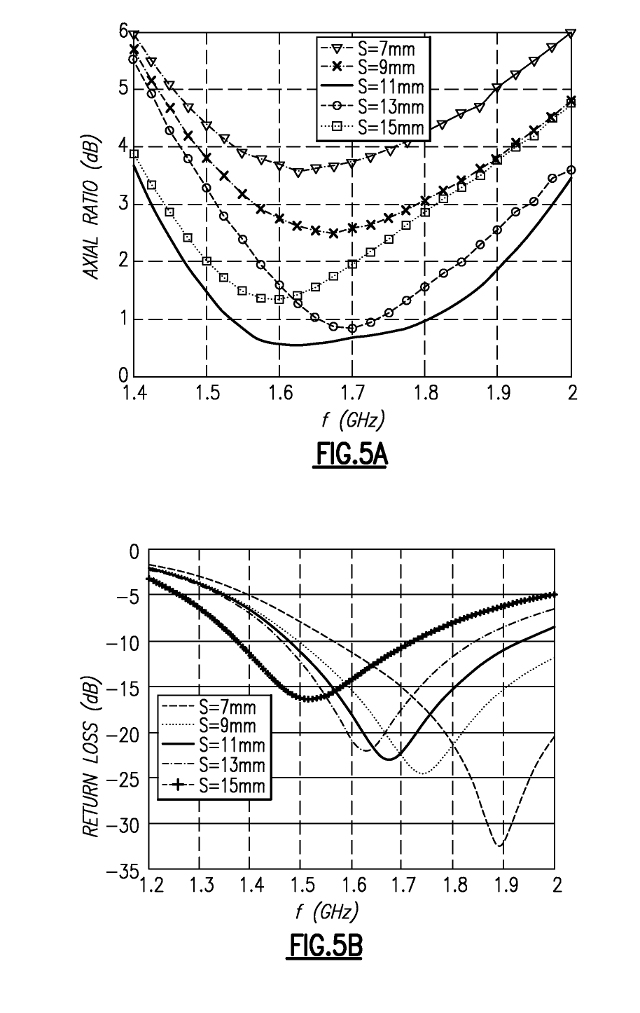

The effect of the slot width variation on axial ratio and return loss bandwidths are demonstrated in FIG. 5a & b. The slot length variation is obtained by changing the upper edge of the horizontal slot and left edge of the vertical slot. In this case the distance between the lower arm of the feed and lower edge horizontal slot is constant. For S=7 mm the axial ratio bandwidth is zero (axial ratio>3 dB) and the resonance frequency is shifted toward the higher frequency. By increasing the slot width the axial ratio bandwidth is improved and the resonance frequency is shifted toward the lower frequencies. For S>11 mm axial ratio bandwidth starts to decrease which causes its overlapped portion with the return loss bandwidth or the circular polarization bandwidth reduces significantly.

Varying Horizontal Feed Line

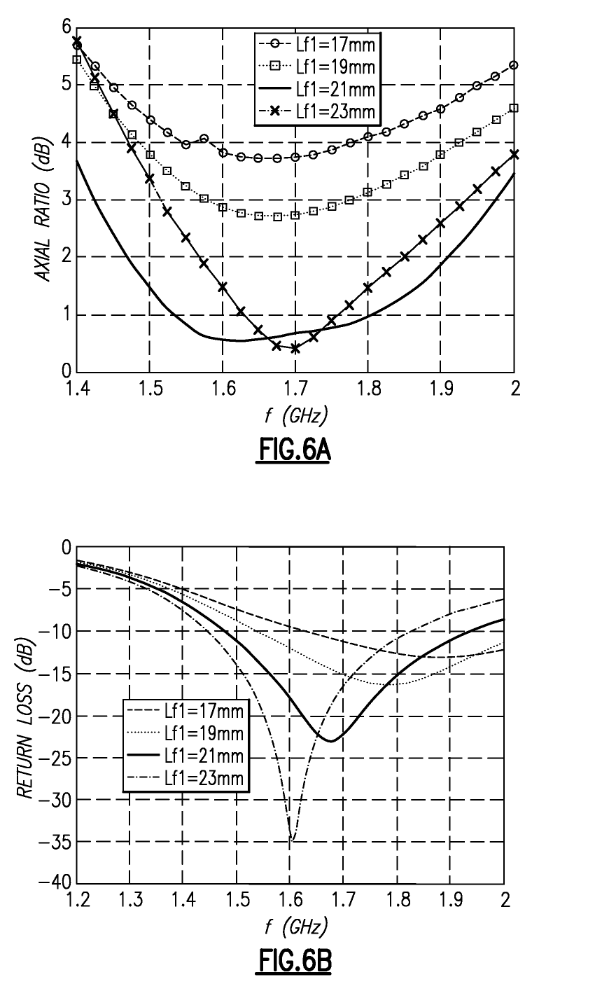

FIG. 6a & b demonstrate the effect of varying the length of the horizontal portion of the feed line on the AR and return loss of the antenna. By increasing the length of the feed line the return loss frequency band of better than −10 dB is moved from higher frequency to lower frequency. For L_{f1}=17 mm the axial ratio bandwidth is zero (axial ratio>3 dB). This is increased by increasing the length of the feed line. The optimum performance is achieved at L_{f1}=21 mm which where the largest overlapped bandwidth between axial ratio and return loss occurs. Beyond that the return loss bandwidth is reduced considerably.

### CONCLUSIONS

A low profile low cost L-shaped monopole slot antenna with C-shaped feed is provided. The simulation and measurement results proved that the antenna has wideband circular polarization performance of 23%. Due to the geometry of the antenna (λ/4 monopole slot) it occupies a half real-estate on the corner of circuit board compared to λ/2 slot antenna that requires the area at the center of the board. This feature significantly facilitates the floor planning and signal routing in a high density mobile device environments operates at lower gigahertz range which the footprint and profile are major concerns. The antenna does not require any truncation corner, reflector surface and via connection which would increase the fabrication cost.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. An antenna comprising:
a substrate;
a ground plane formed on the substrate, the ground plane having a pair of monopole
slots in an L-shaped configuration to produce circular polarization; and
a C-shaped feed line on the substrate.

2. The antenna of claim 1 wherein the C-shaped feed line includes a lower arm and a parallel upper arm connected by vertical portion.

3. The antenna of claim 2 wherein the lower arm is parallel to one of the monopole slots.

4. The antenna of claim 3 wherein the lower arm is aligned with the one of the monopole slots.

5. The antenna of claim 4 wherein the lower arm and the upper arm terminate at an edge of the substrate.

6. The antenna of claim 5 further including a connector connected to the upper arm.

7. The antenna of claim 6 wherein the lower arm is open at the edge of the substrate.

8. The antenna of claim 7 wherein the antenna does not have a truncation adjacent the monopole slots.
